(19) United States
(12) Patent Application Publication
(10) Pub. No.: US 2014/0151211 A1
(43) Pub. Date: Jun. 5, 2014

(54) LUMINOUS KEYBOARD

(71) Applicant: CHANGSHU SUNREX TECHNOLOGY CO., LTD., Changshu (CN)

(72) Inventor: Qing ZHANG, Changshu (CN)

(73) Assignee: CHANGSHU SUNREX TECHNOLOGY CO., LTD., Changshu (CN)

(21) Appl. No.: 13/705,912

(22) Filed: Dec. 5, 2012

(51) Int. Cl. H01H 13/702

(52) U.S. Cl. CPC H01H 13/702
USPC 200/5 A

(57) ABSTRACT

A luminous keyboard includes: a plurality of key caps; a light guiding plate disposed under the key caps; a reflector disposed under the light guiding plate; a masking layer disposed between the key caps and the light guiding plate; a membrane circuit unit disposed under the key caps and on the masking layer; and a luminous unit having a conductive lead, and an illuminant electrically connected to the conductive lead. The conductive lead is made of a material including a conductive polymer gel and a conductive powder and is formed directly on one of the reflector, the masking layer and the membrane circuit unit.

### BACKGROUND OF THE INVENTION

1. Field of the Invention

This invention relates to a luminous keyboard, more particularly to a luminous keyboard having backlight functionality.

2. Description of the Related Art

A conventional luminous keyboard comprises: a press key module and a backlight module including a luminous unit and disposed under the press key module.

The luminous unit is generally formed on a flexible substrate by consecutive steps of copper plating, layer forming, developing and etching. The manufacturing cost is relatively high due to the complex manufacturing process and the costly material.

On the other hand, since the flexible substrate is stacked with other components of the backlight module, e.g., a masking layer, a light guiding plate (LGP), a reflector and so on, the conventional luminous keyboard has a relatively thick structure.

### SUMMARY OF THE INVENTION

Therefore, an object of the present invention is to provide a luminous keyboard that can overcome the aforesaid drawbacks associated with the prior art.

Accordingly, a luminous keyboard of this invention comprises:

a plurality of key caps;

a light guiding plate disposed under the key caps;

a reflector disposed under the light guiding plate;

a masking layer disposed between the key caps and the light guiding plate;

a membrane circuit unit disposed under the key caps and on the masking layer; and

a luminous unit having a conductive lead and an illuminant electrically connected to the conductive lead, the conductive lead being made of a material including a conductive polymer gel and a conductive powder and being formed directly on one of the reflector, the masking layer and the membrane circuit unit.

The effect of this invention resides in that a conductive lead is directly formed on one of the membrane circuit unit, the masking layer, and the reflector. Thus, a flexible substrate used in the conventional luminous keyboard can be omitted, thereby reducing size of the keyboard and simplifying manufacturing steps so as to reduce manufacturing time and costs.

### BRIEF DESCRIPTION OF THE DRAWINGS

In drawings which illustrate preferred embodiments of the invention,

FIG. 1 is an exploded perspective view of a luminous keyboard in the first preferred embodiment according to this invention;

FIG. 2 is a fragmentary exploded perspective view showing a luminous unit disposed on an upper surface of a reflector of the luminous keyboard in the first preferred embodiment;

FIG. 3 is a fragmentary assembled perspective view of FIG. 2;

FIG. 4 is a schematic view showing a progressing path of light generated from an illuminant of the luminous keyboard in the first preferred embodiment;

FIG. 5 is an exploded perspective view of a luminous keyboard in the second preferred embodiment according to this invention;

FIG. 6 is a fragmentary exploded perspective showing a luminous unit disposed on a lower surface of a masking layer of the luminous keyboard of the second preferred embodiment;

FIG. 7 is a fragmentary assembled perspective view of FIG. 6;

FIG. 8 is a schematic view showing a progressing path of light incident from an illuminant of the luminous keyboard in the second preferred embodiment;

FIG. 9 is an exploded perspective view of a luminous keyboard in the third preferred embodiment according to this invention;

FIG. 10 is a fragmentary exploded perspective view showing a luminous unit disposed on a lower surface of a membrane circuit unit of the luminous keyboard in the third preferred embodiment;

FIG. 11 is a fragmentary assembled perspective view of FIG. 10; and

FIG. 12 is a schematic view showing a progressing path of light incident from an illuminant of the luminous keyboard in the third preferred embodiment.

### DETAILED DESCRIPTION OF THE PREFERRED EMBODIMENTS

Before the present invention is described in greater detail, it should be noted herein that like elements are denoted by the same reference numerals throughout the disclosure.

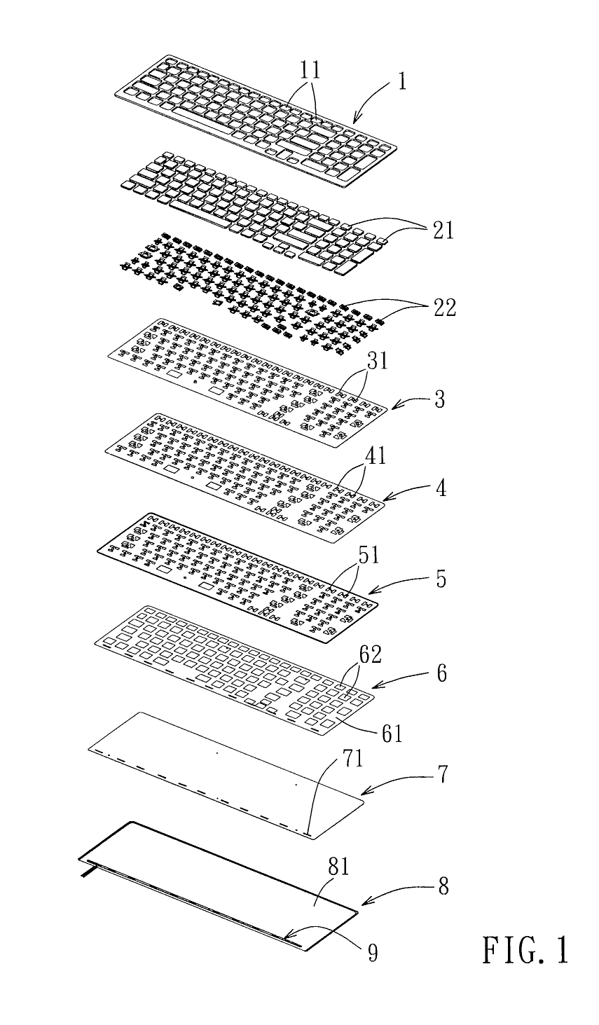

FIG. 1 illustrates a luminous keyboard in the first preferred embodiment according to this invention. The luminous keyboard comprises a frame 1, a plurality of key caps 21, a plurality of scissor linkages 22 and rubber domes (not shown) disposed under the key caps 21, a thin film 3 disposed under the scissor linkages 22 and the rubber domes, a membrane circuit unit 4 disposed under the thin film 3, and a base plate 5 disposed under the membrane circuit unit 4. Specifically, the frame 1 is formed with a plurality of openings 11 for passage of the key caps 21 such that the key caps 21 are exposed from the frame 1. The frame 1, the thin film 3, the membrane circuit unit 4, and the base plate 5 are bonded together by hot melting. When one of the key caps 21 is pressed, a respective one of the rubber domes is pressed to make electrical connection at one of electric connection points (not shown) of the membrane circuit unit 4 so as to generate an electrical signal. In this embodiment, symbol regions (not shown) of the key caps 21, that are formed with symbols, are made of a transparent material for light transmission. Preferably, the thin film 3 is a Mylar film.

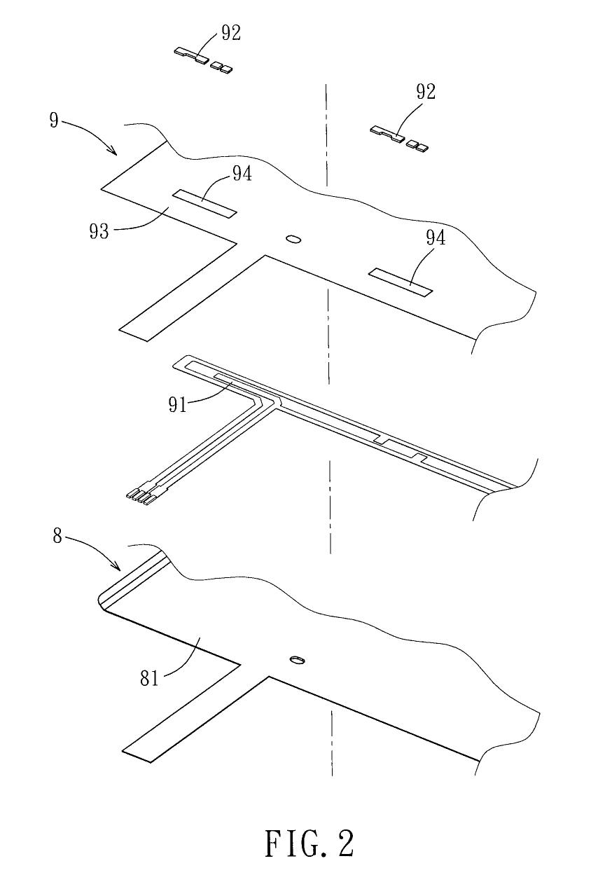

Referring to FIGS. 1 to 3, the luminous keyboard further comprises a masking layer 6 disposed under the base plate 5, a light guiding plate 7 disposed under the masking layer 6, a reflector 8 disposed under the light guiding plate 7, and a luminous unit 9. The base plate 5, the masking layer 6, the light guiding plate 7, and the reflector 8 are stacked and bonded together using an adhesive. The luminous unit 9 includes a conductive lead 91 and a plurality of spaced apart illuminants 92 which are electrically connected to the conductive lead 91. The conductive lead 91 is made of a material including a conductive polymer gel and conductive powder which includes silver in this embodiment.

In this embodiment, the reflector 8 has an upper surface 81. The conductive lead 91 is formed on the upper surface 81 of the reflector 8 by screen printing. The luminous unit 9 further has a cover layer 93 disposed on the upper surface 81 of the reflector 8 and covering the conductive lead 91. The cover layer 93 is formed with a plurality of through holes 94 corresponding in position to the illuminants 92. Each of the illuminants 92 penetrates through and protrudes from a respective one of the through holes 94 so as to be exposed from the cover layer 93.

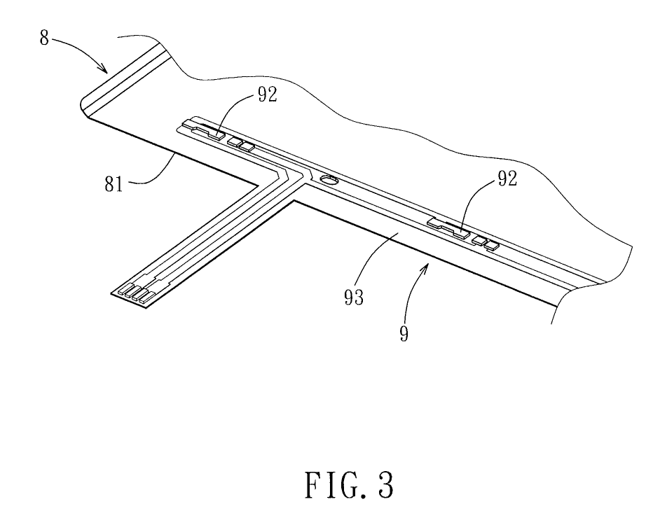

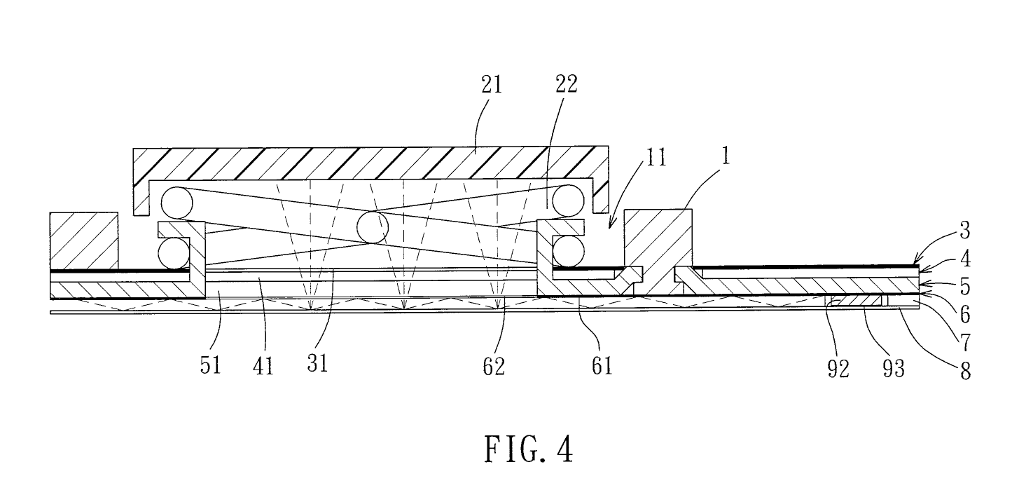

Referring to FIGS. 3 and 4, only one of the key caps 21 and one of the illuminants 92 are shown to illustrate a progressing path of light from the illuminant 92. The light guiding plate 7 is formed with a plurality of perforations 71 (see FIG. 1) for receiving the illuminants 92. The masking layer 6 is formed with an opaque region 61 and a plurality of light transmissible regions 62 corresponding in position to the key caps 21. Besides, each of the thin film 3, the membrane circuit unit 4, and the base plate 5 are respectively formed with through holes 31, 41, 51 corresponding in position to the key caps 21. Light generated from the illuminants 92 are incident on the light guiding plate 7. Part of light guided to the masking layer 6 by the light guiding plate 7 passes through the light transmissible regions 62 of the masking layer 6 and the through holes 51, 41, 31 of the base plate 5, the membrane circuit unit 4, and the thin film 3 so as to provide an illuminating effect for the symbols regions of the key caps 21. Moreover, another part of the light guided to the opaque region 61 of the masking layer 6 by the light guiding plate 7 is reflected to the light guiding plate 7. The reflector 8 is capable of reflecting light to the light guiding plate 7 so as to raise light utilization efficiency.

Preferably, part of a lower surface of the light guiding plate 7 corresponding in position to the key caps 21 is coated with a light reflecting layer, such as reflective ink (not shown), to further increase light reflecting efficiency, thereby increasing brightness of the symbol regions of the key caps 21.

It should be noted that the luminous unit 9 may be designed to have only one illuminant 92. Accordingly, the cover layer 93 and the light guiding plate 7 may be designed to have a through hole 94 and a perforation 71, respectively.

In this embodiment, the conductive lead 91 is directly formed on the upper surface 81 of the reflector 8 by screen printing such that a flexible substrate is not required, thereby reducing size of the luminous keyboard and lowering manufacturing costs.

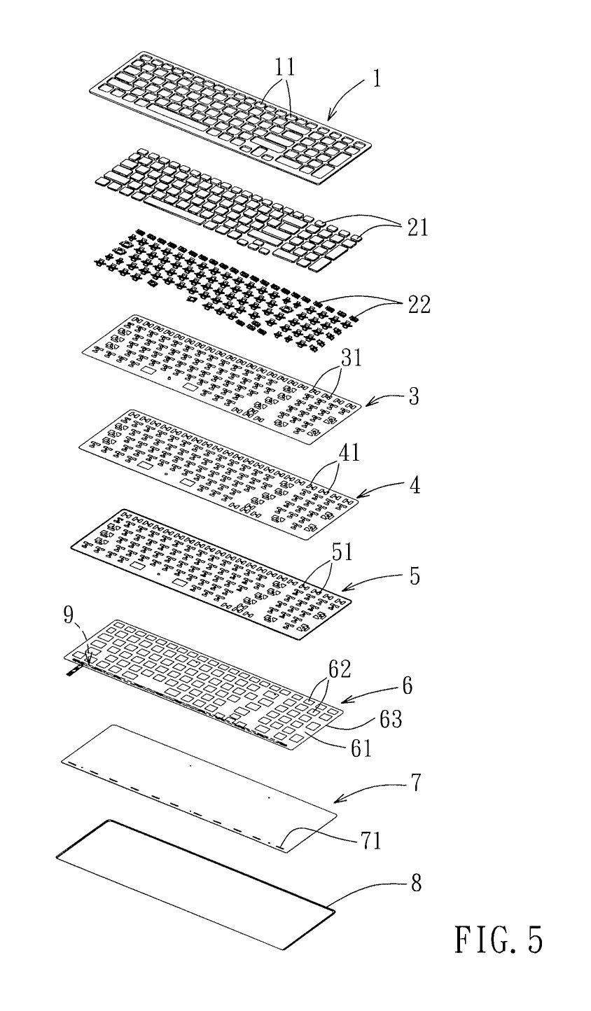

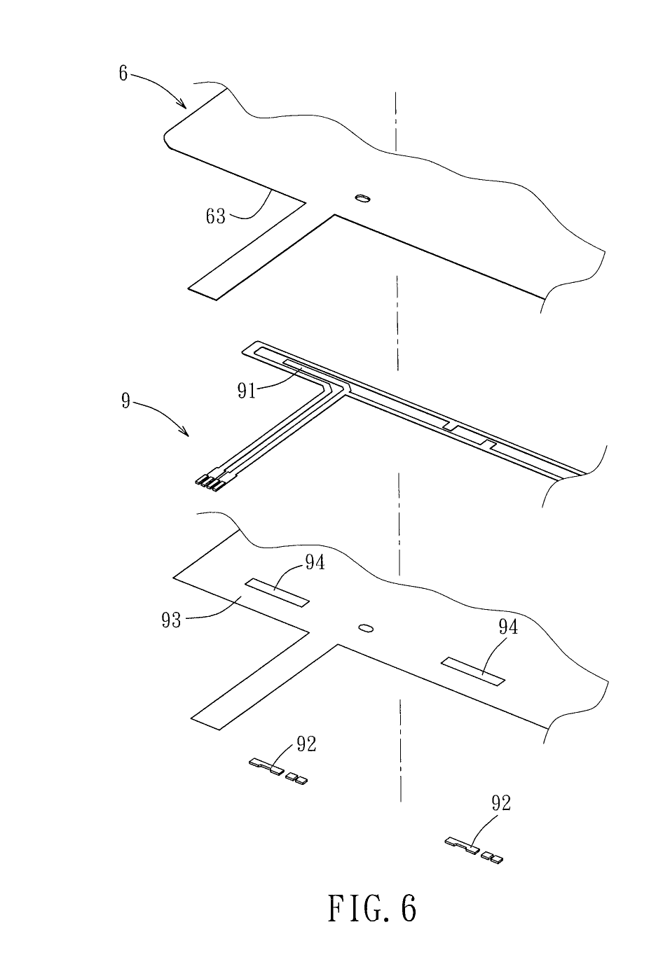

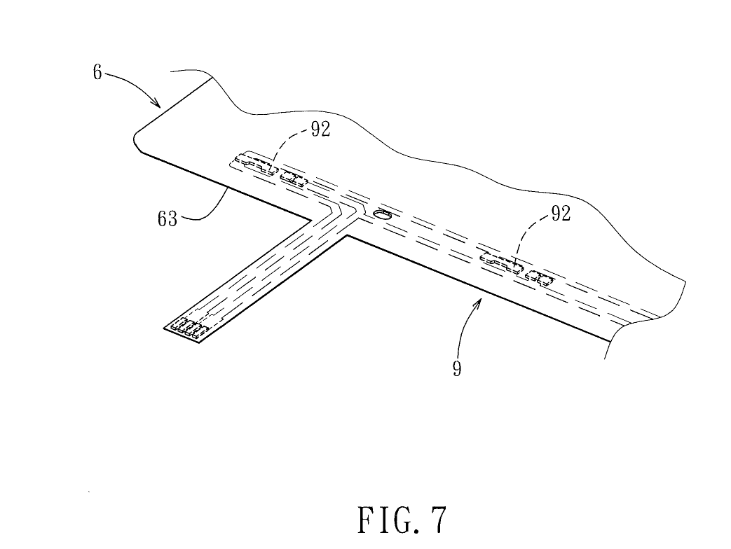

Referring to FIGS. 5 to 7, a luminous keyboard according to the second preferred embodiment of this invention is similar to that of the first preferred embodiment except that the luminous unit 9 in the second preferred embodiment is disposed on a lower surface 63 of the masking layer 6.

In detail, the conductive lead 91 of the luminous unit 9 is formed on the lower surface 63 of the masking layer 6 by screen printing. The cover layer 93 of the luminous unit 9 is disposed on the lower surface 63 of the masking layer 6 and covers the conductive lead 91.

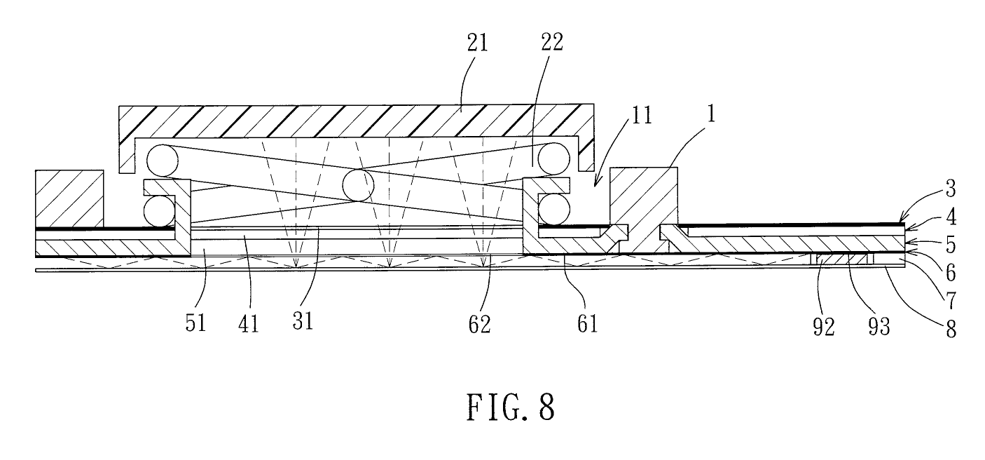

FIG. 8 illustrates a progressing path of light from the illuminant 92. Since the progressing path in the second preferred embodiment is similar to that in the first preferred embodiment, further explanation is omitted herein for the sake of brevity.

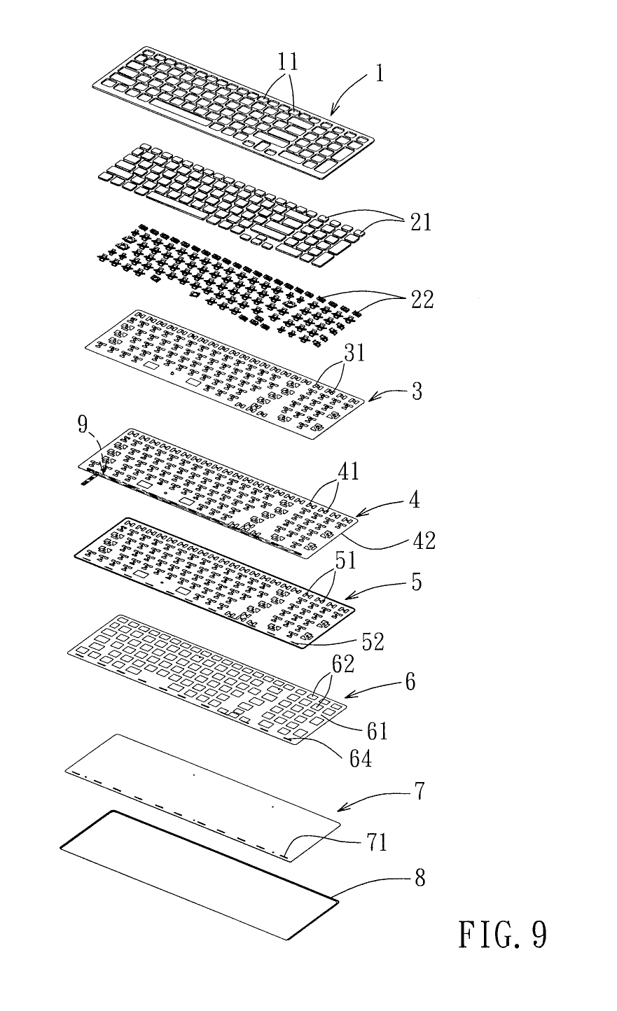

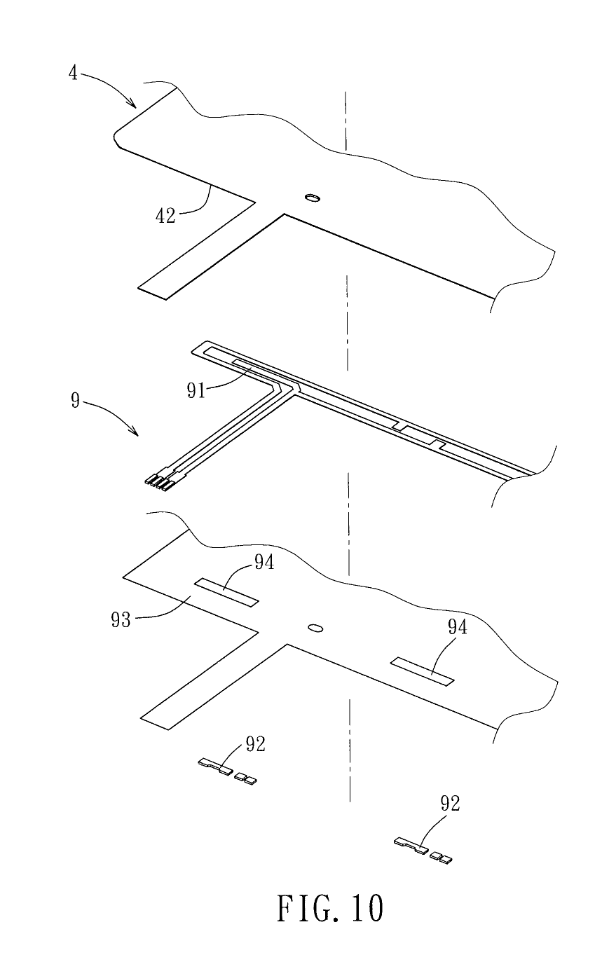

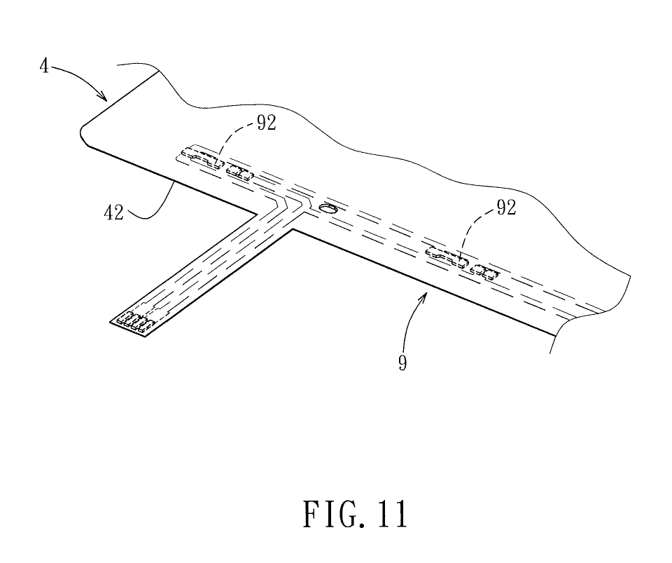

Referring to FIGS. 9 to 11, a luminous keyboard according to the third preferred embodiment of this invention is similar to that in the first preferred embodiment except that the luminous unit 9 is disposed on a lower surface 42 of the membrane circuit unit 4.

Specifically, the conductive lead 91 is formed on the lower surface 42 of the membrane circuit unit 4 by screen printing. The cover layer 93 of the luminous unit 9 is disposed on the lower surface 42 of the membrane circuit unit 4 and covers the conductive lead 91. In this embodiment, aside from the light guiding plate 7, each of the base plate 5 and the masking layer 6 is also formed with a plurality of spaced apart perforations 52, 64 corresponding in position to the illuminants 92. Alternatively, the luminous unit 9 can have only one illuminant 92, and thus, the cover layer 93 and each of the base plate 5, the masking layer 6, and the light guiding plate 7 can be formed with one through hole 93 and one perforation 52, 64, 71, respectively.

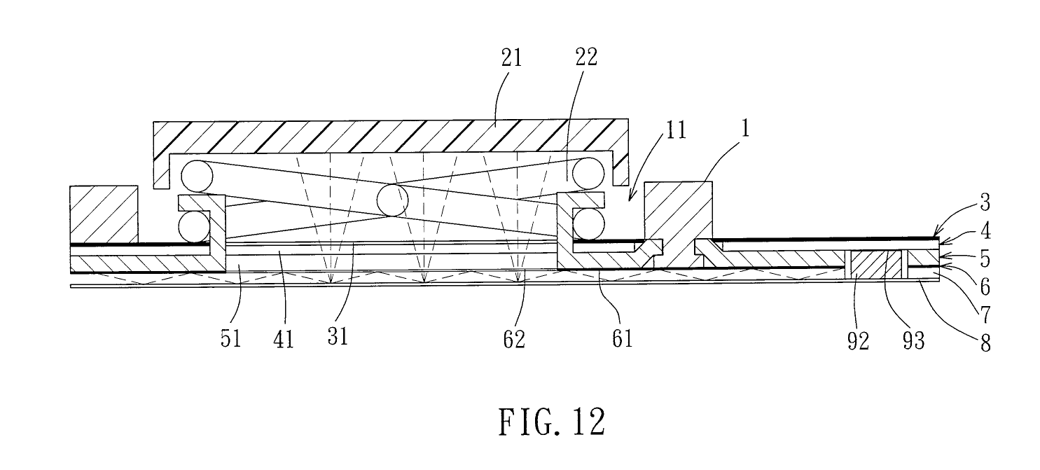

FIG. 12 illustrates a progressing path of light from the illuminant 92. Since the progressing path in the third preferred embodiment is similar to that in the first preferred embodiment, further explanation is omitted herein for the sake of brevity.

In summary, in the luminous ,keyboard according to this invention, since the conductive lead 91 is formed directly on one of the membrane circuit unit 4, the masking layer 6, the reflector 8, a flexible substrate utilized in the prior art can be omitted, thereby reducing size of the luminous keyboard and as well as manufacturing time and costs.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

What is claimed is:

1. A luminous keyboard comprising:
a plurality of key caps;
a light guiding plate disposed under said key caps;
a reflector disposed under said light guiding plate;
a masking layer disposed between said key caps and said light guiding plate;
a membrane circuit unit disposed under said key caps and on said masking layer; and
a luminous unit having a conductive lead, and an illuminant electrically connected to said conductive lead, said conductive lead being made of a material including a conductive polymer gel and a conductive powder and being formed directly on one of said reflector, said masking layer and said membrane circuit unit.

2. The luminous keyboard of claim 1, wherein said conductive lead is formed by screen printing.

3. The luminous keyboard of claim 1, wherein said conductive powder includes silver.

4. The luminous keyboard of claim 1, wherein said reflector includes an upper surface, and said conductive lead is formed on said upper surface of said reflector.

5. The luminous keyboard of claim 4, wherein said light guiding plate is formed with a perforation for receiving said illuminant.

6. The luminous keyboard of claim 5, wherein said luminous unit further includes a cover layer disposed on said upper surface of said reflector and covering said conductive lead, said cover layer being formed with a through hole through which said illuminant extends.

7. The luminous keyboard of claim 1, wherein said masking layer has a lower surface, said conductive lead being formed on said lower surface of said masking layer.

8. The luminous keyboard of claim 7, wherein said light guiding plate is formed with a perforation for receiving said illuminant.

9. The luminous keyboard of claim 8, wherein said luminous unit further includes a cover layer disposed on said lower surface of said masking layer and covering said conductive lead, said cover being formed with a through hole through which said illuminant extends.

10. The luminous keyboard of claim 1, wherein said membrane circuit unit has a lower surface, said conductive lead being formed on said lower surface of said membrane circuit unit.

11. The luminous keyboard of claim 10, further comprising a base plate disposed between said masking layer and said membrane circuit unit, each of said masking layer, said base plate and said light guiding plate being formed with a perforation for receiving said illuminant.

12. The luminous keyboard of claim 11, wherein said luminous unit further includes a cover layer disposed on said lower surface of said membrane circuit unit and covering said conductive lead, said cover layer being formed with a through hole through which said illuminant extends.
